(19) United States
(12) Patent Application Publication
(10) Pub. No.: US 2015/0195864 A1
(43) Pub. Date: Jul. 9, 2015

(54) METHODS AND APPARATUSES FOR P-CSCF RESTORATION BASED ON UE CAPABILITIES

(71) Applicant: TELEFONAKTIEBOLAGET L M ERICSSON (PUBL), Stockholm (SE)

(72) Inventors: Maria Cruz Bartolomé Rodrigo, Madrid (ES); Juan Manuel Fernandez Galmes, Getafe (Madrid) (ES); Ivo Sedlacek, Hovorcovice (CZ)

(21) Appl. No.: 14/593,101

(22) Filed: Jan. 9, 2015

Related U.S. Application Data
(60) Provisional application No. 61/925,403, filed on Jan. 9, 2014.

(51) Int. Cl. H04W 76/02; H04L 29/06; H04W 88/18; H04W 76/06

(52) U.S. Cl. CPC H04W 76/028; H04W 76/068; H04L 65/1016; H04W 88/182; H04L 65/1073

(57) ABSTRACT

The present invention faces the issue of UE enabled to communicate with an IP Multimedia Subsystem following protocol versions older than Release 9, and provides for an alternative P-CSCF restoration procedure. In this alternative P-CSCF restoration procedure, the UE submits to the IMS network UE capability information indicating that the UE is enabled to receive a list with one or more further available P-CSCF entities and to re-register in the IMS network with one of them; at least one entity of the IMS network stores this UE capability information; upon detecting unavailability of the P-CSCF entity to handle a terminating request towards the UE, the UE capability information is provided towards and access network entity; the access network entity determines based on the received UE capability information that the UE is enabled to receive a list with one or more further available P-CSCF entities, obtains the list with further available P-CSCF entities and submits said list to the UE; and the UE re-registers to a further P-CSCF entity selected from the list.

### TECHNICAL FIELD

The present invention generally relates to IP Multimedia Subsystem (IMS) restoration procedures; and, more specifically, the invention relates to selection of one or another IMS restoration procedure, when a Proxy Call Session Control Function (P-CSCF) fails.

### BACKGROUND

3GPP TR 29.806 v1.0.0 (2013-12) discloses currently existing mechanisms for P-CSCF restoration as well as limitations and drawbacks of such mechanisms, and refers to 3GPP TS 24.229 v12.3.0 (2013-12) and 3GPP TS 23.380 v11.2.0 (2013-12) for further details.

In accordance with 3GPP TR 29.806 v1.0.0, section 4.1.1.1, a mobile IMS user equipment (UE) is unreachable for terminating calls after a P-CSCF failure (either total failure or just a loss of registration data after restart) until one of the following actions occurs: (i) the UE attempts to make an outgoing call; (ii) the UE's registration timer expires, which implies a new registration. This timer value depends on operator configuration preferences, but in the worst case it may take several hours.

A main goal of P-CSCF restoration procedures can be formulated as minimizing the time that the UE is not reachable and thus increasing service availability.

To this end, amongst other solutions applying in different scenarios, 3GPP TR 29.806 discloses the so-called Sol-C: Alternative with AS (via ISC and Sh) and the so-called Sol-D: Alternative with direct Cx communication. Under these two alternatives, the Home Subscriber Server (HSS) requests that the UE releases the IMS Packet Data Network (PDN) connection. Particularly, under Sol-C, the Application Server (AS) triggers the restoration procedure by contacting HSS via Sh interface, whereas under Sol-D, the Serving Call Session Control Function (S-CSCF) triggers the restoration procedure by contacting HSS via Cx interface. Those skilled in the art would recognize ISC as the interface between AS and S-CSCF, Sh as the interface between AS and HSS, and Cx as the interface between S-CSCF and HSS. In accordance with these current standards, the release of the IMS PDN connection by the UE assures that the UE will reactivate the IMS PDN connection and will register again to IMS, using an available P-CSCF, thus becoming again reachable for terminating requests.

More precisely, the release of the IMS PDN connection implies: the Mobility Management Entity (MME) has to send an E-RAB release to the eNodeB and get the reply back; and the PDN Gateway (PGW) is going to tear down its Gx session, and also any Authentication-Authorization-Accounting (AAA) sessions, any Gy sessions etc. are to be released. Those skilled in the art would recognize Gx as the interface between Policy and Charging Rules Function (PCRF) and Policy and Charging Enforcement Function (PCEF), and Gy as the interface between PCEF and Online Charging System (OCS). More precisely, the Gx is the interface between the PCRF and any one of a PGW and a Gateway GPRS Support Node (GGSN), as illustrated in FIG. 1, and as also illustrated on FIG. 4.1.1.2-1 of 3GPP TR 29.806 v1.0.0.

The reactivation of the IMS PDN connection implies: the PGW has to setup Gx, Gy and AAA sessions again; the PCRF has to download rules, e.g. some vendors like Verizon use Sh for communication between PCRF and Subscription Profile Repository (SPR); entire PDN setup procedure, at minimum is an S11 Create Session Request/Response, an S5 Create Session Request/Response and an S11 Modify Bearer Request; and signalling an E-UTRAN Radio Access Bearer (E-RAB) setup and response to the UE and to an evolved Node B (eNodeB).

Thereby, reactivation of the IMS PDN connection is a drawback since requires extra signalling and processing. The IMS PDN release is perceived by vendors and operators as something to avoid.

On the other hand, from Rel-9 onwards, 3GPP TS 23.380 and 3GPP TS 24.229 disclose “Update PDP context/Bearer at P-CSCF failure”, whereby at IMS registration, the P-CSCF, via Rx, informs the PCRF, which informs the PGW of the P-CSCF identity. Then, the PGW monitors the health of the P-CSCF and, in case of failure of the P-CSCF, the PGW updates the list of P-CSCFs in the UE using the Protocol Configuration Options (PCO) functionality, so that the UE selects another P-CSCF for a new initial IMS registration.

This currently specified P-CSCF restoration procedure requires specific support by the UE and cannot be thus applied to all UE registering in the IMS network. At present, UE usually follows what is specified by GSMA and, more particularly for this purpose, by GSMA IR.92, wherein nothing is specified for P-CSCF restoration. Therefore, UE are not mandated to support PCO and are not requested to reconnect to newly provided P-CSCF addresses.

### SUMMARY

The present invention is aimed to at least minimize the above drawbacks and provides for an alternative method for P-CSCF restoration, as well as for enhanced cooperating entities adapted to carry out an alternative P-CSCF restoration procedure, whereby the IMS PDN release is avoided when the UE is enabled to re-register to IMS using a new available P-CSCF.

In accordance with a first aspect of the present invention, there is provided a method executed at a UE for P-CSCF restoration in an IMS network. This method comprises sending a register message to a P-CSCF entity, the register message initiating a registration procedure and comprising UE capability information indicating that the UE is enabled to receive a list with one or more further available P-CSCF entities and to re-register in the IMS network with one of them. In particular, the register message may be intended to register the UE in the IMS network.

Particularly advantageous when the P-CSCF fails, this method may further comprise receiving from an access network entity a request intended to cause the UE to re-register in the IMS network, the request including a list with one or more further available P-CSCF entities; and sending a further register message to a further P-CSCF entity selected from the list with one or more further available P-CSCF entities. In particular, the further register message may be intended to re-register the UE in the IMS network.

In accordance with a second aspect of the present invention, there is provided a method for P-CSCF restoration in an IMS network, the method executed at one or more serving entities assigned for serving a UE in the IMS network.

This method comprises receiving a register message originated from a UE via a P-CSCF entity, wherein the register message initiates a registration procedure and comprises UE capability information indicating that the UE is enabled to receive a list with one or more further available P-CSCF entities and to re-register in the IMS network with one of them, storing by the serving entity the received UE capability information, and completing the registration procedure. In particular, the register message may be intended to register the UE in the IMS network. In an embodiment of the invention, the serving entity may be an S-CSCF entity of the IMS network. In another embodiment, the one or more serving entities may be the S-CSCF entity and an AS of the IMS network.

Particularly advantageous when an invite message is received through one or more service entities, e.g. the S-CSCF alone or the S-CSCF and the AS, this method may further comprise, upon forwarding to the P-CSCF entity the invite message received by the one or more serving entities, detecting by at least one of the one or more serving entities unavailability of the P-CSCF entity to handle the invite message, and sending from one of the at least one detecting serving entity towards an access network entity, via a HSS, a request to start P-CSCF restoration, wherein the request submitted to the access network entity includes the UE capability information. In particular, the one or more serving entities receiving the invite message may include either an S-CSCF entity, or an S-CSCF entity and an AS of the IMS network.

In an embodiment, the S-CSCF entity may be the serving entity receiving and forwarding the invite message to the P-CSCF entity, detecting the unavailability of the P-CSCF entity, and sending the request to start P-CSCF restoration via the HSS.

In another embodiment, the S-CSCF entity and the AS may be the serving entities receiving the invite message, the S-CSCF entity may be the serving entity forwarding the invite message to the P-CSCF entity, the S-CSCF entity and the AS may be the serving entities detecting the unavailability of the P-CSCF entity, and the AS may be the serving entity sending the request to start P-CSCF restoration via the HSS.

Particularly applicable for any embodiment of this method, storing by the serving entity the received UE capability information may include storing the received UE capability information in at least one of the S-CSCF entity and the AS of the IMS network. Alternatively, storing by the serving entity the received UE capability information may include submitting the received UE capability information from the receiver serving entity, which may be the S-CSCF entity, towards at least one of the HSS and the AS, for storing therein.

In accordance with a third aspect of the present invention, there is provided a method for P-CSCF restoration in an IMS network, the method executed at an access network entity through which a UE accesses the IMS network.

This method comprises receiving from an IMS network entity a request to start P-CSCF restoration, wherein the request includes UE capability information indicating that the UE is enabled to receive a list with one or more further available P-CSCF entities and to re-register in the IMS network with one of them, obtaining from a gateway the list with one or more further available P-CSCF entities, and sending to the UE a request intended to cause the UE to re-register in the IMS network, the request including the list with one or more further available P-CSCF entities.

In an embodiment of this method, the access network entity may be an entity in charge of mobility management. In particular for this embodiment, the access network entity may be a mobility management entity, MME, and the gateway may be at least one of a serving gateway, S-GW, and a packet data network gateway, P-GW. In particular for this embodiment, the access network entity may also be a serving GPRS support node, SGSN, and the gateway may be a gateway GPRS support node, GGSN.

In accordance with a fourth aspect of the present invention, there is provided a UE enabled to communicate with an IMS network.

This UE comprises a transmitter adapted to send a register message to a P-CSCF entity of the IMS network, the register message initiating a registration procedure and comprising UE capability information indicating that the UE is enabled to receive a list with one or more further available P-CSCF entities and to re-register in the IMS network with one of them. In particular, the register message may be intended to register the UE in the IMS network.

Particularly advantageous when the P-CSCF fails, this UE may further comprise a receiver adapted to receive from an access network entity a request intended to cause the UE to re-register in the IMS network, the request including a list with one or more further available P-CSCF entities, and the transmitter of this UE may further be adapted to send a further register message to a further P-CSCF entity selected from the list with one or more further available P-CSCF entities. In particular, the further register message may be intended to re-register the UE in the IMS network.

In accordance with a fifth aspect of the present invention, there is provided a serving entity assigned for serving a UE in an IMS network.

This serving entity comprises a receiver adapted to receive a register message originated from a UE, via a P-CSCF entity of the IMS network, the register message initiating a registration procedure and comprising UE capability information indicating that the UE is enabled to receive a list with one or more further available P-CSCF entities and to re-register in the IMS network with one of them; and a processor adapted to trigger the received UE capability information being internally stored in a local memory or being submitted for storage, through a transmitter, towards a further serving entity, and also adapted to trigger completion of the registration procedure. In particular, the register message may be intended to register the UE in the IMS network. In an embodiment of the invention, the serving entity may be an S-CSCF entity of the IMS network and the further serving entity may be an AS or a HSS. In another embodiment, the serving entity may be an AS and the further serving entity may be a HSS.

Particularly advantageous when an invite message is received through one or more service entities, e.g. the S-CSCF entity alone or both the S-CSCF entity and the AS, the serving entity may comprise a transmitter adapted to forward to the P-CSCF entity the invite message received by the one or more serving entities, the processor of the serving entity may be adapted to detect, upon forwarding to the P-CSCF entity the invite message, unavailability of the P-CSCF entity to handle the invite message, and the transmitter of the serving entity may be adapted to trigger, via at least one of a HSS and a further serving entity, the submission of a request to start P-CSCF restoration towards an access network entity, wherein the request includes the UE capability information.

In a case where the S-CSCF entity is the only serving entity receiving the invite message, the transmitter of the S-CSCF entity may be adapted to forward to the P-CSCF entity the invite message, the processor of the S-CSCF entity may be adapted to detect the unavailability of the P-CSCF entity to handle the invite message, and the transmitter of the S-CSCF entity may be adapted to send the request to start P-CSCF restoration towards the access network entity via the HSS.

In a case where both the S-CSCF entity and the AS are the serving entities receiving the invite message, the transmitter of the S-CSCF entity may be adapted to forward to the P-CSCF entity the invite message, the processor of the S-CSCF entity may be adapted to detect the unavailability of the P-CSCF entity to handle the invite message, and the transmitter of the S-CSCF entity may be adapted to trigger, via the AS and the HSS, the submission of the request to start P-CSCF restoration towards an access network entity, wherein the request includes the UE capability information. To this end, the transmitter of the S-CSCF entity may be adapted to notify the AS of the unavailability of the P-CSCF entity to handle the invite message, and a transmitter of the AS may be adapted to submit, via the HSS, the request to start P-CSCF restoration towards an access network entity.

In an embodiment, the processor of the S-CSCF entity may be adapted to store the received UE capability information in a local memory of the S-CSCF entity. In an alternative or complementary embodiment, the transmitter of the S-CSCF entity may be adapted to submit the received UE capability information towards at least one of a HSS and an AS to be stored therein.

In accordance with a sixth aspect of the present invention, there is provided an access network entity for mobility management of a UE, which accesses an IMS network.

This access network entity comprises a receiver adapted to receive from an IMS network entity a request to start a P-CSCF restoration, wherein the request includes UE capability information indicating that the UE is enabled to receive a list with one or more further available P-CSCF entities and to re-register in the IMS network with one of them, a processor adapted to obtain, from a gateway, the list with one or more further available P-CSCF entities, and a transmitter adapted to send to the UE a request intended to cause the UE to re-register in the IMS network, the request including the list with one or more further available P-CSCF entities.

In an embodiment aligned with a method discussed above, the access network entity may be an MME and, then, the gateway may be at least one of an S-GW and a P-GW. In another embodiment also aligned with a method discussed above, the access network entity may be an SGSN and, then, the gateway may be a GGSN.

In accordance with a seventh aspect of the present invention, there is provided a system for P-CSCF restoration in an IMS network.

This system comprises a P-CSCF entity of the IMS network adapted to receive from a UE a register message with UE capability information indicating that the UE is enabled to receive a list with one or more further available P-CSCF entities and to re-register in the IMS network with one of them, and adapted to forward the register message with the UE capability information towards an S-CSCF entity. In this system at least one of the S-CSCF entity, a HSS and an AS of the IMS network is adapted to receive and store the UE capability information.

In this system, at least one of the S-CSCF entity and the AS is adapted to receive a terminating invite message; the S-CSCF entity is adapted to forward the terminating invite message towards the P-CSCF entity; and at least one of the S-CSCF entity and the AS is adapted to detect unavailability of the P-CSCF entity and to send towards an access network entity, via the HSS, a request to start P-CSCF restoration, the request including the UE capability information.

This system also comprises the access network entity adapted, based on the received UE capability information, to send to the UE a request intended to cause the UE to re-register in the IMS network, the request including a list with one or more further available P-CSCF entities.

In accordance with an eighth aspect of the present invention, there is provided a computer program comprising instructions which, when executed on at least one processor, cause the at least one processor to carry out the method steps of any one of methods discussed above.

In accordance with a ninth aspect of the present invention, there is provided a method for P-CSCF restoration in an IMS network.

This method comprises a UE submitting to the IMS network, via a P-CSCF entity, a register message with UE capability information indicating that the UE is enabled to receive a list with one or more further available P-CSCF entities and to re-register in the IMS network with one of them. This method comprises storing this UE capability information in at least one of an S-CSCF, an AS and an HSS of the IMS network.

This method comprises, upon detecting unavailability of the P-CSCF entity to handle a terminating request towards the UE, providing the UE capability information via the HSS towards at least one of an MME and an SGSN.

This method comprises, based on the received UE capability information, the at least one of MME and SGSN sending to the UE a list with one or more further available P-CSCF entities, and sending a further register message, from the UE to a further P-CSCF entity selected from the list with one or more further available P-CSCF entities. In particular, the further register message may be intended to re-register the UE in the IMS network.

### BRIEF DESCRIPTION OF THE DRAWINGS

The features, objects and advantages of the invention will become apparent by reading this description in conjunction with the accompanying drawings, in which:

FIG. 1 basically represents a currently existing P-CSCF restoration mechanism.

FIG. 2 shows an exemplary sequence of actions that may be performed to provide UE capability information for P-CSCF restoration.

FIG. 3 shows an exemplary sequence of actions where UE capability information indicates no support for P-CSCF restoration.

FIGS. 4a and 4b show an exemplary sequence of actions where UE capability information indicates support for P-CSCF restoration, in accordance with a first scenario.

FIGS. 5a and 5b show an exemplary sequence of actions where UE capability information indicates support for P-CSCF restoration, in accordance with a second scenario.

FIG. 6 shows an exemplary sequence of actions where UE capability information indicates support for P-CSCF restoration, in accordance with a third scenario.

FIG. 7 shows a basic component structure of a UE in accordance with an embodiment of the invention.

FIG. 8 shows a basic component structure of an exemplary serving entity, an S-CSCF, in accordance with an embodiment of the invention.

FIG. 9 shows a basic component structure of an exemplary access network entity, an MME/SGSN, in accordance with an embodiment of the invention.

### DETAILED DESCRIPTION

The following describes embodiments of an alternative method for P-CSCF restoration and for enhanced cooperating entities adapted to carry out an alternative P-CSCF restoration procedure, whereby the UE IMS PDN disconnection is avoided when the UE is able to re-register to IMS using a new available P-CSCF.

Prior to discussing the P-CSCF restoration procedure, it is worthwhile to describe the existing P-CSCF Restoration procedures, as described from Rel-9 onwards in 3GPP TS 23.380 and 3GPP TS 24.229.

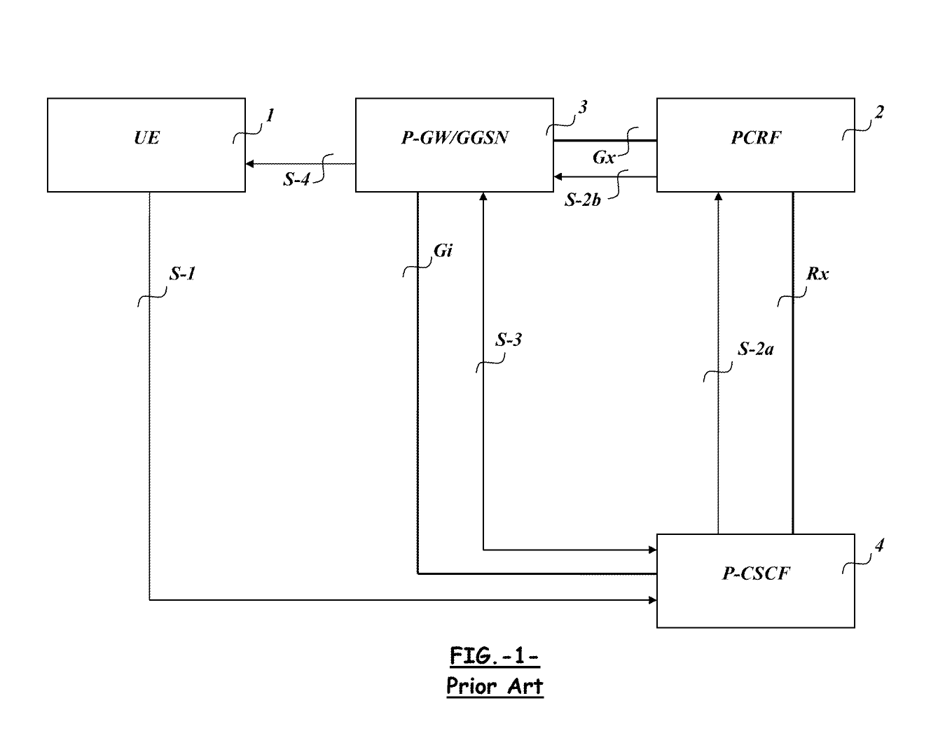

This existing P-CSCF restoration procedure may be summarized with reference to FIG. 1.

As shown in FIG. 1, the UE 1 initially registers to IMS during a step S-1 using a P-CSCF 4 selected by the UE. In connection with the UE registration, the P-CSCF 4 selected by the UE provides via Rx the PCRF 2 with its P-CSCF address, i.e. a SIP address, during a step S-2a. The PCRF 2 in its turn uses a Gx push procedure to provide this P-CSCF address to the P-GW/GGSN 3 during a step S-2b. The P-CSCF address is then stored by P-GW/GGSN.

Then, during step S-3, the P-GW/GGSN 3 monitors periodically the availability of all P-CSCFs to which the UEs it serves are attached to. In particular, the P-GW/GGSN 3 monitors the P-CSCF 4 which the UE selected to register into IMS.

When the P-GW/GGSN 3 considers the P-CSCF 4 as failed or unavailable, i.e. during a step S-4, the P-GW/GGSN 3 sends Update Bearer Request/Update PDP Context Request to all UEs associated with this P-CSCF 4, in particular to the UE 1, including a new PCO (Protocol Configuration Options) IE with a list of available P-CSCF addresses, which does not include the P-CSCF address of the failed P-CSCF 4.

The UE 1, upon receiving the Update Bearer Request/Update PDP Context Request (with the list of P-CSCF addresses) will perform a new initial registration towards IMS, by using a different P-CSCF, since former P-CSCF will not be included in the list.

Therefore, this current restoration mechanism requires specific UE support, since the UE shall be able to re-register to any of the newly provided P-CSCF addresses.

If the UE supports existing Rel-9 P-CSCF Restoration procedures, then it is able to receive a list of available P-CSCFs, and then it can be required to register to IMS using one of the available P-CSCFs in that list. Therefore, with this mechanism a new available P-CSCF may be selected, and then the UE may be newly reachable for terminating requests, while IMS PDN connection is not released.

However, not all the UEs support this Rel-9 P-CSCF Restoration procedure. On the contrary, GSMA compliant UEs just need to follow the Rel-8 3GPP TS 24.229 that only include P-CSCF discovery mechanism and not P-CSCF restoration procedures, since the P-CSCF restoration trigger based on Update Bearer Request/Update PDP Context Request was introduced in Rel-9 as an optional procedure in 3GPP TS 24.229. Therefore, the UE may ignore any P-CSCF address in an Update Bearer Request/Update PDP Context Request, and then will not perform a new registration and as a result continue to be unavailable.

Therefore, this invention proposes a method to identify whether affected UE supports Rel-9 P-CSCF Restoration procedures and, based on this support, the invention provides for an alternative P-CSCF restoration procedure. If the UE supports Rel-9 P-CSCF Restoration procedure, then a procedure is defined to reuse existing P-CSCF restoration procedure and provide the UE with an updated list of available P-CSCFs. Then UE registers to IMS using a valid P-CSCF. If the UE does not support Rel-9 P-CSCF restoration procedure, the UE is requested to release IMS PDN connection, what requires (according to standards) to reactivate again the IMS PDN connection and then register to IMS (and for this, only an available P-CSCF can be selected).

In accordance with embodiments of the invention, and further disclosed in respect of different scenarios, the alternative P-CSCF restoration procedure provides for:
a UE 1 submitting to the IMS network (P-CSCF 4 and S-CSCF 5) UE capability information about whether this UE supports Rel-9 P-CSCF Restoration procedures;
storing this UE capability information in S-CSCF 5, in AS 9 or in HSS 6;
when P-CSCF fails, and handling a terminating request towards a destination user is not possible, S-CSCF is able to provide the UE capability information via HSS to MME/SGSN 7; and
based on UE capability information (new indication), MME/SGSN is able to avoid UE IMS PDN release when the UE supports Rel-9 P-CSCF Restoration procedures. So that the MME/SGSN may send to the UE, a list with one or more further available P-CSCF entities, and the UE may send a further register message to a further P-CSCF entity selected from the list with one or more further available P-CSCF entities.

Advantageously, the invention avoids IMS PDN disconnection for a UE. This disconnection implies the need for a new IMS PDN reactivation, and this reactivation requires extra signalling. Therefore, avoiding the IMS PDN disconnection for the UE implies extra signalling is avoided. Extra signalling is considered as a disadvantage by 3GPP vendors and operators.

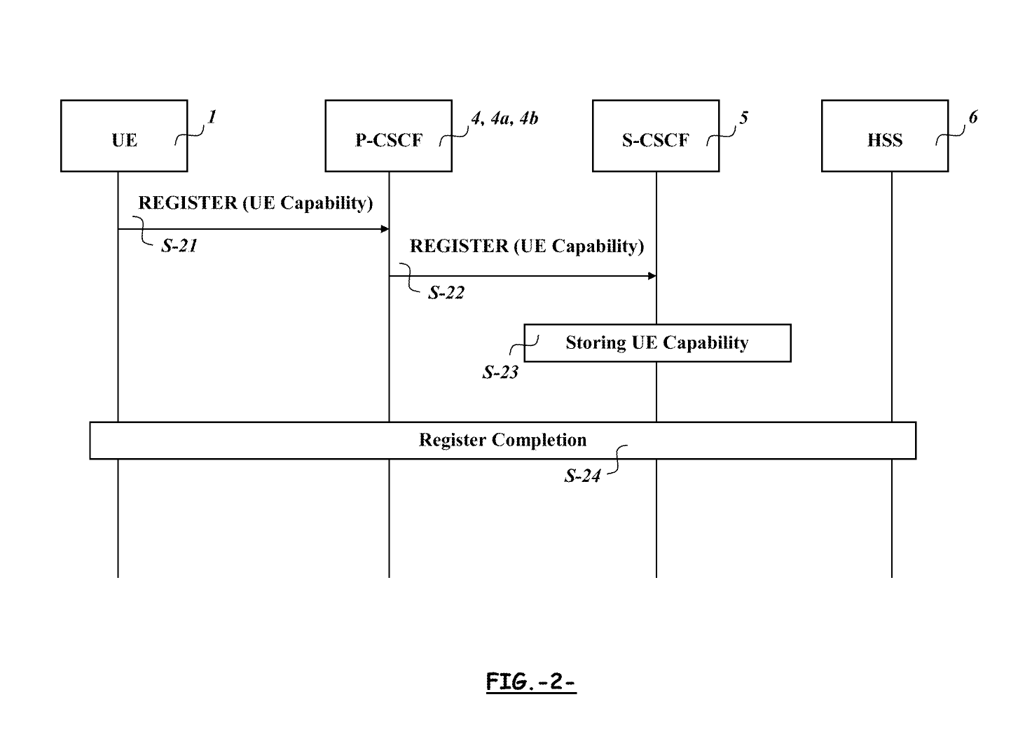

In an embodiment illustrated in FIG. 2 usable in this alternative P-CSCF restoration procedure, the UE provides at IMS registration an indication in case it supports Rel-9 P-CSCF Restoration. This indication of supporting Rel-9 P-CSCF Restoration is hereinafter referred to as UE capability information indicating that the UE is enabled to receive a list with one or more further available P-CSCF entities and to register in the IMS network with one of them.

As illustrated in FIG. 2, the UE 1 sends during a step S-21 a register message to a P-CSCF entity 4, wherein the register message is intended to register the UE in an IMS network and comprises UE capability information indicating that the UE is enabled to receive a list with one or more further available P-CSCF entities and to register in the IMS network with one of them. In particular, this UE capability information may be provided in the Contact header as a feature tag.

The P-CSCF entity 4 forwards the register message with the UE capability information towards a serving entity assigned for serving the UE in the IMS network. In particular, this serving entity may be the S-CSCF 5, as illustrated in FIG. 2. Particular sub-embodiments are further provided for other scenarios, whereby the S-CSCF entity 5 might optionally involve a further serving entity, such as an AS. In this embodiment, the S-CSCF 5 stores during a step S-23 the UE capability information. This UE capability can be identified by a pair IMS private identity (IMPI)/IMS public identity (IMPU).

Then, the registration procedure is completed during a step S-24.

In embodiments where one or more serving entities are involved, at least one of one or more serving entities may store the received UE capability information, and complete the registration procedure.

In particular, the absence of the UE capability information in the register message may be assumed by a receiver entity as UE capability information indicating that the UE is not enabled to receive a list with one or more further available P-CSCF entities and to register in the IMS network with one of them.

More particularly, the P-CSCF entity 4 may be the receiver entity detecting the absence of the UE capability information in the register message, and may include the assumed UE capability information, indicating that the UE is not enabled to receive a list with one or more further available P-CSCF entities and to register in the IMS network with one of them, in the register message before forwarding the register message towards the serving entity. Alternatively, the serving entity, e.g. S-CSCF 5, may be the receiver entity detecting the absence of the UE capability information in the register message, and may store the assumed UE capability information, indicating that the UE is not enabled to receive a list with one or more further available P-CSCF entities and to register in the IMS network with one of them.

Once entities of the IMS network are aware of the UE capability information received or assumed for the UE, embodiments of the alternative P-CSCF restoration procedure can be disclosed in respect of different scenarios.

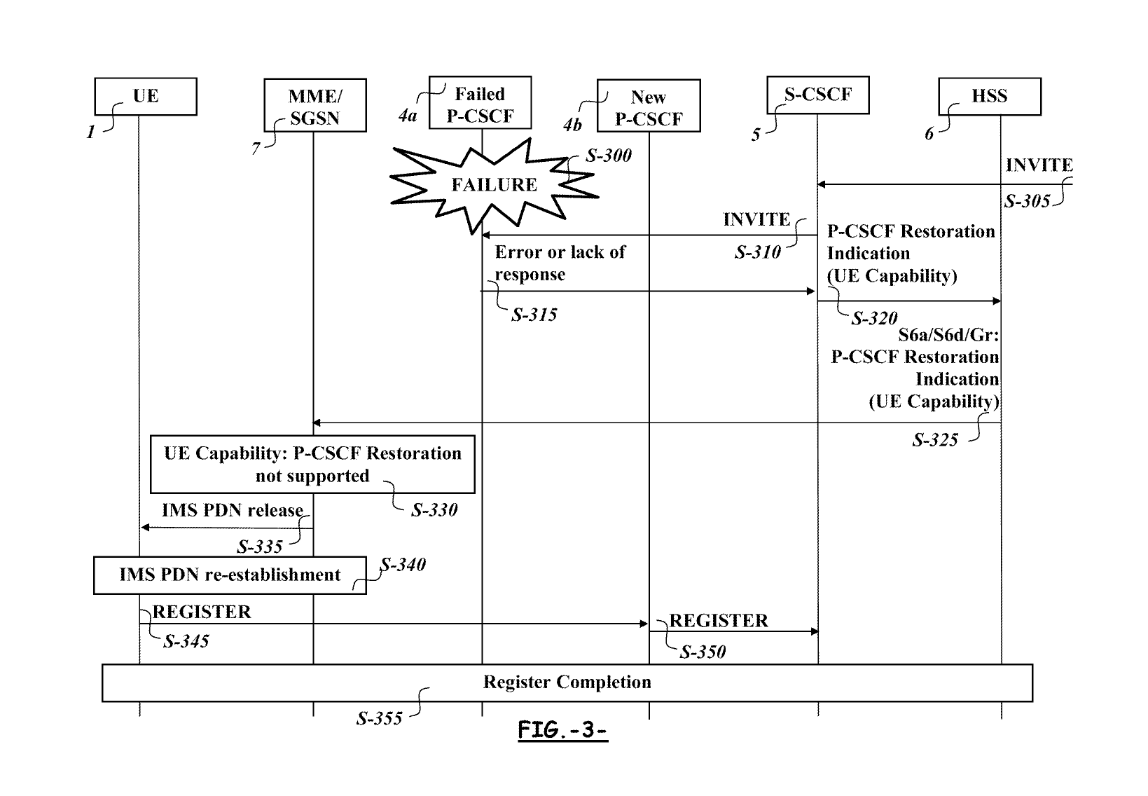

FIG. 3 illustrates an embodiment where the UE does not support Rel-9 P-CSCF Restoration procedures, so that an IMS PDN release is required for the UE.

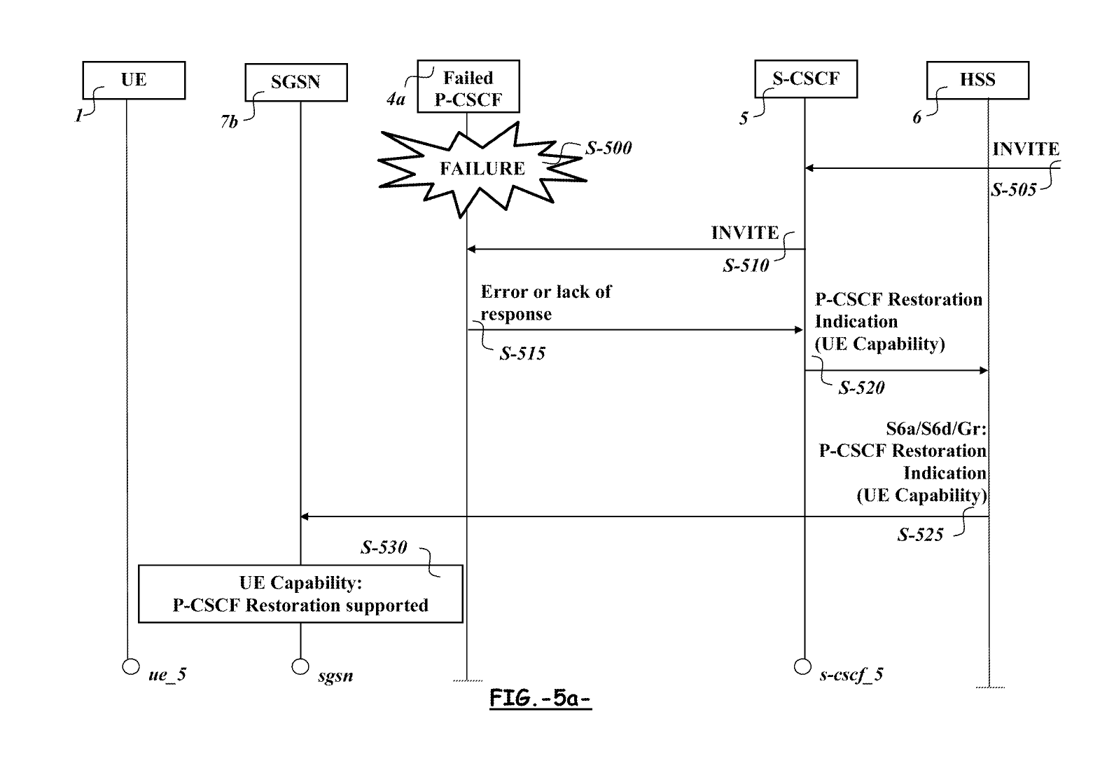

As illustrated in FIG. 3, a serving entity such as a terminating S-CSCF 5 receives during a step S-305 an invite message for the UE. In this embodiment, the S-CSCF 5 is the only serving entity involved in receiving the invite message. Steps in this FIG. 3 correspond to those in 3GPP TR 29.806 FIG. 6.5.3.1-1, but amended in accordance with an embodiment of the present invention.

The S-CSCF 5 knows the P-CSCF through which the UE has registered to the IMS network, by following the exemplary embodiment commented above with reference to FIG. 2. The S-CSCF 5 is not aware that a failure has occurred during a step S-300 in such P-CSCF, which for the purpose of the embodiment illustrated in FIG. 3, corresponds to the failed P-CSCF 4a.

The S-CSCF tries to reach the UE through this known P-CSCF. To this end, the S-CSCF forwards during a step S-310 the received invite message to the failed P-CSCF 4a. Depending on the severity of the failure, the failed P-CSCF may provide an error message or no response at all. Such error message or the lack of a response makes the S-CSCF detect unavailability of the failed P-CSCF 4a during a step S-315.

Upon detecting the unavailability of the failed P-CSCF entity to handle the invite message, the S-CSCF may identify whether or not the destination UE (identified by IMPI/IMPU) supports Rel-9 P-CSCF Restoration procedures, based on the embodiment explained above with reference to FIG. 2, i.e. based on the UE capability information that was stored in the S-CSCF.

Then, the S-CSCF 5 sends towards an access network entity, which is in charge of mobility management, a request to start P-CSCF restoration and this request may include the UE capability information.

This request to start the P-CSCF restoration, along with the UE capability information, may be sent from the S-CSCF during a step S-320 to a HSS 6, and the HSS may forward during a step S-325 the received request to start the P-CSCF restoration with the UE capability information towards the access network entity 7. In particular, this access network entity may be an MME or an SGSN.

Alternatively, if the UE capability information is not received in the request received from the S-CSCF, the HSS 6 could have also stored such UE capability information as part of an enhanced completion of registration procedure and may include the stored UE capability information in the request to start the P-CSCF restoration forwarded towards the access network entity 7.

Upon receiving at the access network entity 7, e.g. at the MME/SGSN, during the step S-325 the request to start the P-CSCF restoration, which may or may not include the UE capability information, the MME/SGSN determines during a step S-330 that, in this case, the UE capability information indicates the UE does not support the Rel-9 P-CSCF Restoration procedures.

Then, the MME/SGSN sends during a step S-335 an IMS PDN connection release request to the UE 1. The UE initiates re-establishment of the PDN connection during a step S-340 and IMS registration during a step S-345. To this end, the UE sends a register message to a new P-CSCF 4b, which is available, and the new P-CSCF forwards this register message to the S-CSCF 5.

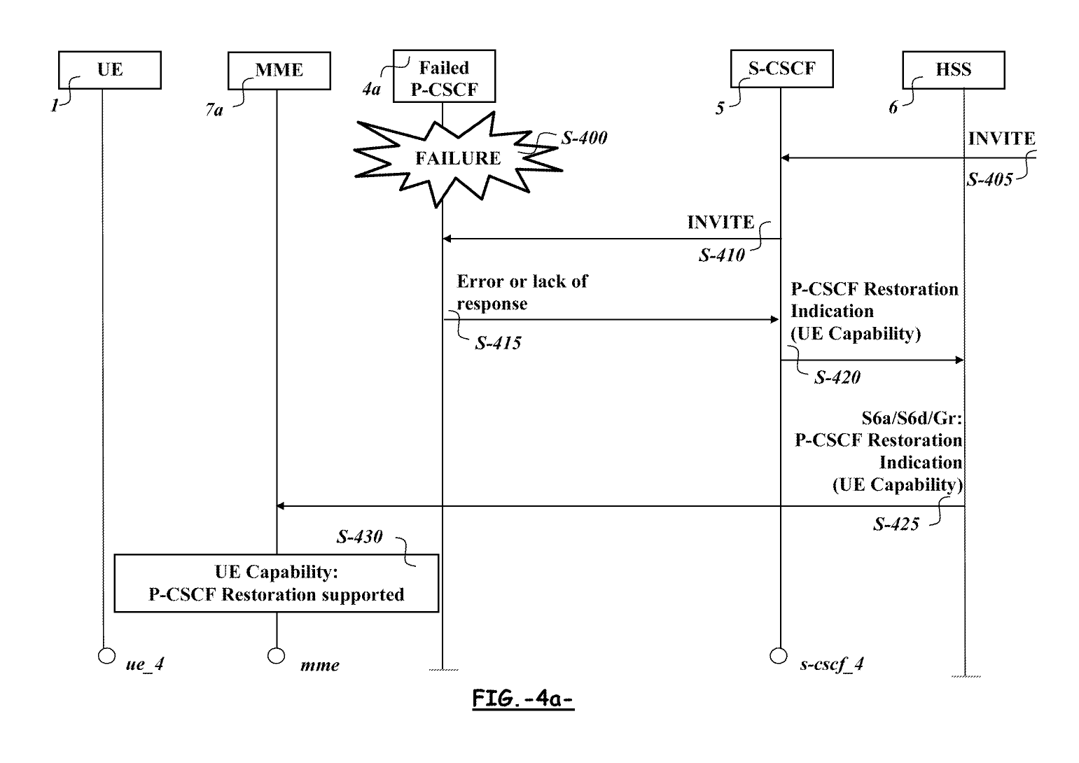

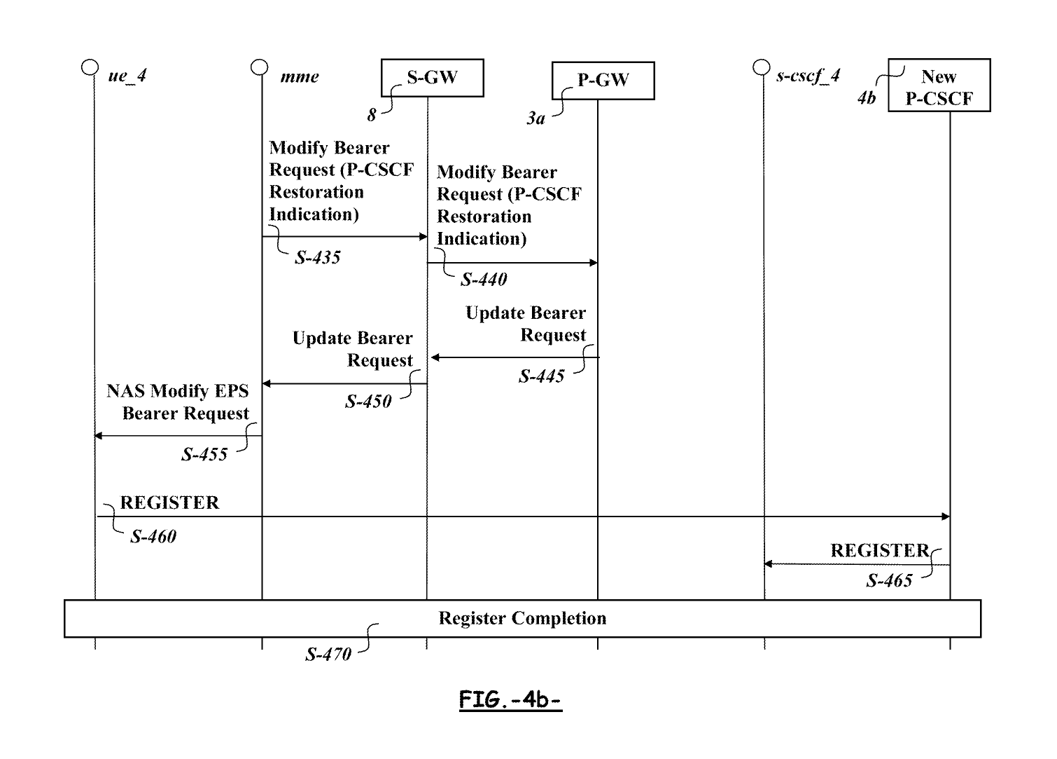

The invention may be applied to the scenario referred to as Sol-D in 3GPP TS 29.806, section 6.5. The solution results in the sequence of actions illustrated in FIG. 4a-4b, for an evolved packet core (EPC) scenario, and in FIG. 5a-5b, for a packet core (PC) scenario.

FIG. 4a and FIG. 4b illustrate an embodiment where the UE supports Rel-9 P-CSCF Restoration procedures in an EPC scenario, so that an IMS PDN release is avoided for the UE.

Steps S-405, S-410, S-415, S-420 and S-425 in the scenario of FIG. 4a correspond to steps S-305, S-310, S-315, S-320 and S-325 in the scenario of FIG. 3. These steps are shortly explained again for the sake of clarity.

A terminating S-CSCF 5 receives during a step S-405 an invite message for the UE and the S-CSCF tries to reach the UE through the P-CSCF 4a where the UE registered to IMS. To this end, the S-CSCF forwards during a step S-410 the received invite message to the failed P-CSCF 4a. The S-CSCF receives either an error code or no response during a step S-415. Then, the S-CSCF 5 sends during a step S-420 a request to start P-CSCF restoration to a HSS 6, and the HSS forwards during a step S-425 the received request to start the P-CSCF restoration towards the access network entity, in this case the MME 7a. This request to start P-CSCF restoration sent from the S-CSCF may include the UE capability information received during the UE registration to IMS, and stored at the S-CSCF. Alternatively, the HSS may include the UE capability information received during the UE registration to IMS, and stored at the HSS in the request to start P-CSCF restoration forwarded towards the MME. This UE capability information indicates the UE supports Rel-9 P-CSCF Restoration procedures, i.e. the UE is enabled to receive a list with one or more further available P-CSCF entities and to register in the IMS network with one of them.

Once the MME 7a receives the request to start P-CSCF restoration in step S-425, the MME checks whether the UE capability information is received and determines in a step S-430 that the UE supports Rel-9 P-CSCF Restoration procedures.

Then, as illustrated in FIG. 4b, the MME 7a sends during a step S-435 a modify bearer request message to a S-GW 8, and the latter forwards during a step S-440 the modify bearer request message towards the P-GW 3a, for the corresponding UE.

This request already exists, but a new indication is included in accordance with an embodiment of the invention to identify that this request is related to a P-CSCF Restoration procedure.

The MME 7a provides this indication to the P-GW 3a via S-GW 8. When the modify bearer request message is received by the S-GW with an indication of P-CSCF Restoration, this message is forwarded to P-GW.

The new P-CSCF Restoration indication in the modify bearer request message is interpreted by the P-GW as a request to initiate UE updating with new available P-CSCF addresses. Therefore, the P-GW includes a list of new available P-CSCF addresses in a PCO field of an update bearer request message sent during a step S-445 from the P-GW to the S-GW, and forwarded during a step S-450 from the S-GW to the MME.

The MME 7a sends during a step S-455 a corresponding update bearer request to the UE.

This corresponding request also includes a PCO field with the list of available P-CSCF addresses. Then, the UE can select one available P-CSCF from the list and initiate an IMS registration. To this end, the UE sends during a step S-460 a register message to the selected new P-CSCF 4b, the new P-CSCF forwards during a step S-465 the register message to the S-CSCF 5, and the registration is completed during a step S-470.

As commented above, FIG. 5a and FIG. 5b also illustrate an embodiment where the UE supports Rel-9 P-CSCF Restoration procedures, so that an IMS PDN release is avoided for the UE. But, instead of applying in the evolved packet core (EPC) scenario shown in FIG. 4a and FIG. 4b, the embodiment illustrated in FIG. 5a and FIG. 5b applies in a packet core (PC) scenario.

In this embodiment, steps S-505, S-510, S-515, S-520 and S-525 in the scenario of FIG. 5a correspond to steps S-405, S-410, S-415, S-420 and S-425 in the scenario of FIG. 4a, with the only difference of the access network entity being a SGSN 7b in the PC scenario, instead of the MME 7a of the EPC scenario. An explanation for the steps illustrated in FIG. 5a can be read in corresponding passages explained above with reference to FIG. 4a.

However, the actions carried out by the SGSN 7b, as illustrated in FIG. 5b are somewhat different that those carried out by the MME 7a.

Once the SGSN 7b has determined that the UE supports Rel-9 P-CSCF Restoration procedures during the step S-530 shown in FIG. 5a, then, as illustrated in FIG. 5b, the SGSN 7b sends during a step S-535 a modify PDP context message to a GGSN 3b, for the corresponding UE.

This message already exists, but a new P-CSCF Restoration indication is included in accordance with an embodiment of the invention to identify that this request is related to a P-CSCF Restoration procedure.

The new P-CSCF Restoration indication in the modify PDP context message is interpreted by the GGSN as a request to initiate UE updating with new available P-CSCF addresses. Therefore, the GGSN includes a list of new available P-CSCF addresses in a PCO field of an update PDP context request message sent during a step S-540 from the GGSN to the SGSN.

The SGSN 7b sends during a step S-545 a corresponding update PDP context request to the UE.

This corresponding request also includes a PCO field with the list of available P-CSCF addresses. Then, the UE can select one available P-CSCF from the list and initiate an IMS registration. To this end, the UE sends during a step S-550 a register message to the selected new P-CSCF 4b, the new P-CSCF forwards during a step S-555 the register message to the S-CSCF 5, and the registration is completed during a step S-560.

On the other hand, further embodiments are possible, may be combined with the embodiments above and are discussed in the following.

In accordance with a first further embodiment, the UE capability information (support for Rel-9 P-CSCF Restoration procedures) might be stored in the AS 9 during UE registration in the IMS network, instead of the S-CSCF 5.

In accordance with a second further embodiment, the UE capability information (support for Rel-9 P-CSCF Restoration procedures) might be stored in the HSS during UE registration, instead of the S-CSCF 5.

The invention may also be applied to the scenario referred to as Sol-C in 3GPP TS 29.806, section 6.4. The solution results in the sequence of actions illustrated in FIG. 6.

The sequence of actions illustrated with reference to FIG. 6 are completed by corresponding sequence of actions respectively illustrated and commented above with reference to FIG. 4a-4b and FIG. 5a-5b, depending on whether the MME or the SGSN is the entity involved.

Nevertheless, for the sake of completeness, the embodiment illustrated in FIG. 6 is discussed in the following.

As illustrated in FIG. 6, a serving entity such as a terminating S-CSCF 5 receives during a step S-605 an invite message for the UE. In this embodiment, the S-CSCF 5 is not the only serving entity involved in receiving the invite message. In this embodiment, the call is routed via the AS using iFC and, to this end, the S-CSCF 5 sends during a step S-610 the invite message for the UE to the AS 9, and the AS acknowledges during a step S-615 the reception. Apart from the AS 9, which is a serving entity for the purpose of the present invention, there may be more AS's involved in this procedure. That is, under this embodiment there are at least two serving entities that receive the invite massage, i.e. the S-CSCF 5 and the AS 9.

Then, the S-CSCF 5, which is not aware of a failure previously suffered by the terminating P-CSCF during a step S-600, forwards during a step S-620 the received invite message towards the failed terminating P-CSCF 4b. Depending on the nature of failure, the failed P-CSCF 4b cannot always respond. Then, the S-CSCF either receives an error message or no response at all. Such error message or the lack of a response makes the S-CSCF 5 detect unavailability of the failed P-CSCF 4a during a step S-625.

Upon detecting the unavailability of the failed P-CSCF entity to handle the invite message, the S-CSCF may identify whether or not the destination UE (identified by IMPI/IMPU) supports Rel-9 P-CSCF Restoration procedures, based on the embodiment explained above with reference to FIG. 2, i.e. based on the UE capability information that was stored in the S-CSCF.

Then, the S-CSCF 5 sends during a step S-630 an error message, which may include indication of the lack of response, towards the AS 9. This error message may include the UE capability information, if stored in the S-CSCF. Upon receiving the error message, the AS determines the UE capability information either from the received error message or from local storage, if the UE capability information had been stored in the AS in accordance with the first further embodiment commented above.

Once the UE capability information has been determined, the AS 9 sends towards an access network entity, which is in charge of mobility management, a request to start P-CSCF restoration and this request may include the UE capability information.

This request to start the P-CSCF restoration, along with the UE capability information, may be sent from the AS 9 during a step S-635 to a HSS 6, and the HSS may forward during a step S-640 the received request to start the P-CSCF restoration with the UE capability information towards the access network entity 7. In particular, this access network entity may be an MME or an SGSN.

Alternatively, if the UE capability information is not received in the request received from the AS 9, the HSS 6 could have also stored such UE capability information as part of an enhanced completion of registration procedure, in accordance with the second further embodiment commented above, and may include the stored UE capability information in the request to start the P-CSCF restoration, which is forwarded during the step S-640 towards the access network entity 7.

Upon receiving at the access network entity 7, e.g. at the MME/SGSN, during the step S-640 the request to start the P-CSCF restoration, the MME/SGSN 7 determines during a step S-645 that, in this case, the UE capability information indicates the UE supports the Rel-9 P-CSCF Restoration procedures.

Then, depending on whether the access network entity is an MME or an SGSN, the procedure explained with reference to FIG. 6 continues with the procedure illustrated in FIG. 4b, if the access network entity is an MME 7a, or with the procedure illustrated in FIG. 5b, if the access network entity is an SGSN 7b.

As different variations may be made on the embodiment explained with reference to FIG. 6, this embodiment generally teaches that, upon forwarding to the failed P-CSCF entity an invite message received by one or more serving entities, one of the one or more serving entities may detect unavailability of the failed P-CSCF entity to handle the invite message. The detecting serving entity may send towards an access network entity, which is in charge of mobility management, via at least one of a HSS and other serving entities, a request to start P-CSCF restoration, wherein the request submitted to the access network entity includes the UE capability information. In particular, the access network entity may be an MME or a SGSN entity.

As different variations may also be made on the embodiments explained with reference to FIG. 4b and FIG. 5b, these embodiment generally teach that, based on the received UE capability information, the access network entity, i.e. an MME or an SGSN, may obtain from a gateway, i.e. P-GW or GGSN, the list with one or more further available P-CSCF entities. Then, the access network entity may send to the UE a request that causes the UE to re-register in the IMS network, wherein the request includes the list with one or more further available P-CSCF entities. Responsive to the request, the UE may send a further register message to a further P-CSCF entity selected from the list with one or more further available P-CSCF entities.

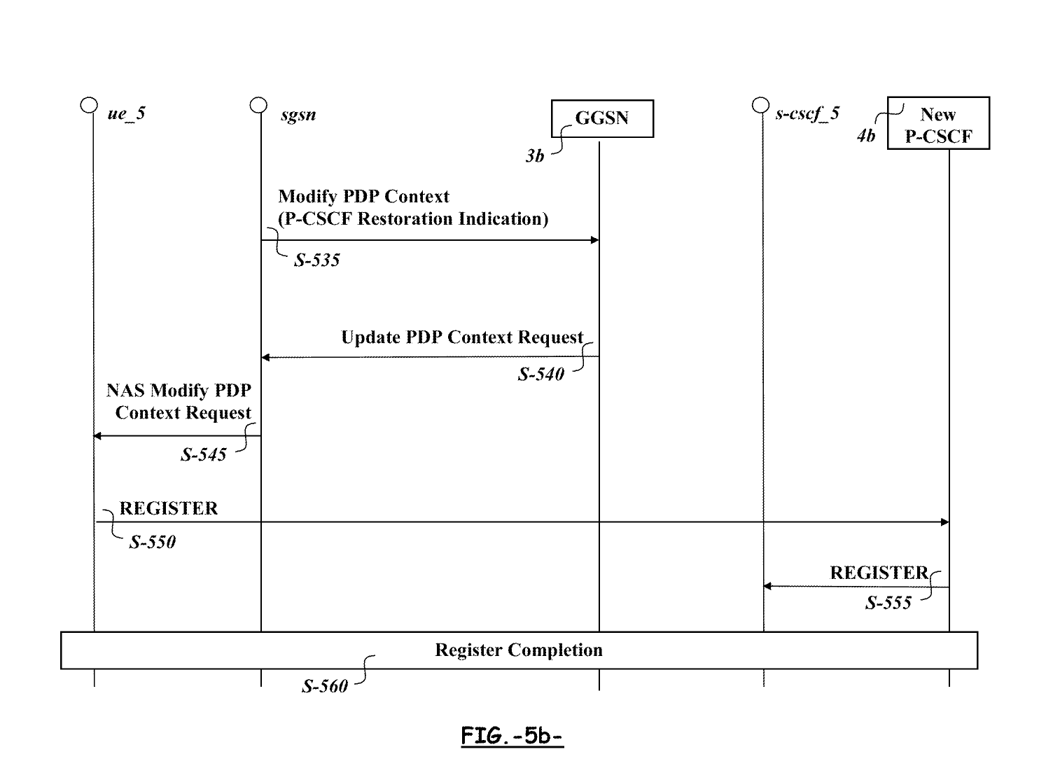

Participating in some methods discussed above, there is provided a UE 1, which is schematically illustrated in FIG. 7.

As shown in FIG. 7, the UE 1 comprises a transmitter 11 adapted to send a register message to a P-CSCF entity of the IMS network, the register message comprising UE capability information indicating that the UE is enabled to receive a list with one or more further available P-CSCF entities and to further register in the IMS network with one of them.

This UE 1 may also comprise a receiver 12 adapted to receive from an access network entity 7 a request intended to cause the UE to re-register in the IMS network, the request including a list with one or more further available P-CSCF entities; and, this case, the transmitter 11 may further be adapted to send a further register message to a further P-CSCF entity selected from the list with one or more further available P-CSCF entities.

The UE 1 shown in FIG. 7 may also comprise at least one processor 10 and at least one memory 13, both in communication with each other, with the transmitter 11 and the receiver 12, and with other elements or units of the UE 1. The at least one processor 10 may be configured to run the functions of the UE 1. The at least one memory 13 may comprise volatile and/or non-volatile memory. In particular, the at least one memory 13 may have a computer program and data stored therein. The computer program may be loaded in the at least one memory 13 from a storage medium, such as any non-transitory computer readable medium, in which the computer program is stored. The data may comprise the list with the one or more further available P-CSCF entities.

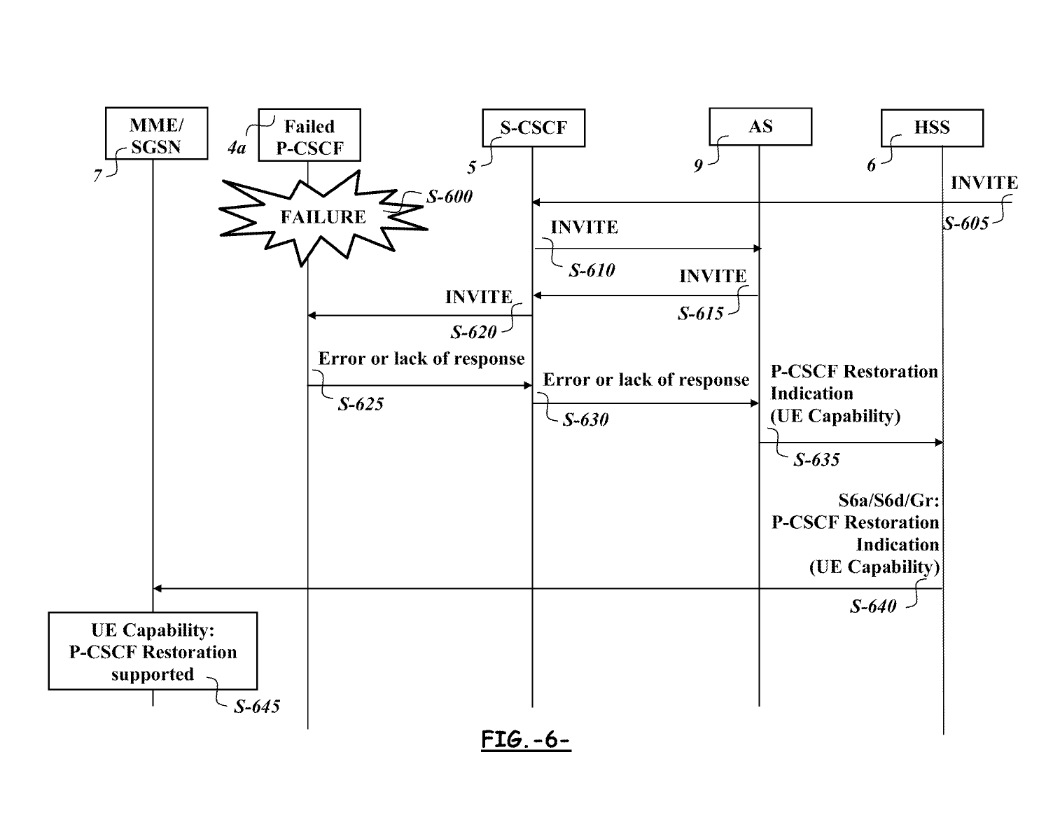

Participating in some methods discussed above, there is also provided an exemplary serving entity, such as the S-CSCF 5, which is schematically illustrated in FIG. 8.

As shown in FIG. 8, the S-CSCF 5 comprises a receiver 52 adapted to receive a register message from a P-CSCF entity of the IMS network, the register message comprising UE capability information indicating that the UE is enabled to receive a list with one or more further available P-CSCF entities and to further register in the IMS network with one of them.

As shown in FIG. 8, the S-CSCF 5 also comprises at least one processor 50 and at least one memory 53, both in communication with each other, and with the receiver 52. The at least one processor 50 is adapted to trigger the received UE capability information being internally stored in the at least one memory 53 or being submitted for storage, through a transmitter 51, towards a further serving entity, and also adapted to trigger completion of the registration procedure.

The S-CSCF 5 shown in FIG. 8 may comprise a transmitter 51 adapted to forward to the P-CSCF entity an invite message received by one or more serving entities. In this case, the at least one processor 50 may be adapted to detect, upon forwarding to the P-CSCF entity the invite message, unavailability of the P-CSCF entity to handle the invite message, and the transmitter 51 may be adapted to trigger the submission towards an access network entity, via at least one of a HSS 6 and one or more further serving entities, of a request to start P-CSCF restoration, wherein the request submitted to the access network entity includes the UE capability information.

As shown in FIG. 8, the at least one processor 50, the at least one memory 53, the receiver 52 and the transmitter 51 are all in communication with each other and with other elements or units of the S-CSCF 5.

The at least one memory 53 may comprise volatile and/or non-volatile memory. In particular, the at least one memory 53 may have a computer program and data stored therein. The computer program may be loaded in the at least one memory 53 from a storage medium, such as any non-transitory computer readable medium, in which the computer program is stored. The data may comprise UE capability information for one or more UE. The at least one processor 50 may be configured to run the functions of the S-CSCF.

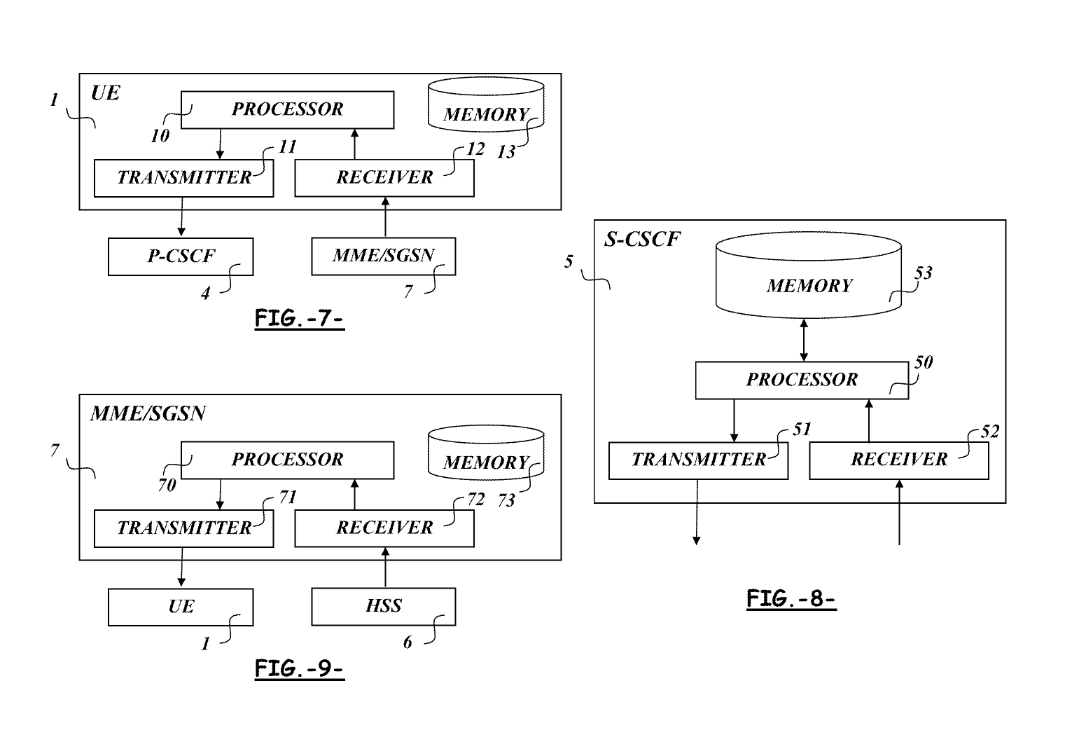

Participating in some methods discussed above, there is also provided an exemplary access network entity, such as the MME/SGSN 7, which is schematically illustrated in FIG. 9.

As shown in FIG. 9, the MME/SGSN 7 comprises a receiver 72 adapted to receive from an IMS network entity a request to start a P-CSCF restoration, wherein the request includes UE capability information indicating that the UE is enabled to receive a list with one or more further available P-CSCF entities and to further register in the IMS network with one of them.

As shown in FIG. 9, the MME/SGSN 7 also comprises at least one processor 70 adapted to obtain, from a gateway, the list with one or more further available P-CSCF entities, and a transmitter 71 adapted to send to the UE a request intended to cause the UE to re-register in the IMS network, the request including the list with one or more further available P-CSCF entities.

As shown in FIG. 9, the at least one processor 70, the receiver 72 and the transmitter 71 are all in communication with each other and with other elements or units of the MME/SGSN 7.

The MME/SGSN 7 shown in FIG. 9 may also comprise at least one memory 73 in communication with the at least one processor 70, the receiver 72 and the transmitter 71, and with other elements or units of the MME/SGSN 7. The at least one processor 70 may be configured to run the functions of the MME/SGSN 7. The at least one memory 73 may comprise volatile and/or non-volatile memory. In particular, the at least one memory 73 may have a computer program and data stored therein. The computer program may be loaded in the at least one memory 73 from a storage medium, such as any non-transitory computer readable medium, in which the computer program is stored. The data may comprise the list with one or more further available P-CSCF entities.

The invention is described above in connection with various embodiments that are intended to be illustrative and non-restrictive. It is expected that those of ordinary skill in this art may modify these embodiments. The scope of the invention is defined by the claims in conjunction with the description and drawings, and all modifications that fall within the scope of the claims are intended to be included therein.

1. A method executed at a user equipment (UE) for Proxy Call Session Control Function (P-CSCF) restoration in an IP Multimedia Subsystem (IMS) network; the method comprising:
sending a register message to a P-CSCF entity, the register message initiating a registration procedure and comprising UE capability information indicating that the UE is enabled to receive a list with one or more further available P-CSCF entities and to re-register in the IMS network with one of them.

2. The method of claim 1, further comprising:
receiving from an access network entity a request intended to cause the UE to re-register in the IMS network, the request including a list with one or more further available P-CSCF entities; and
sending a further register message to a further P-CSCF entity selected from the list with one or more further available P-CSCF entities.

3. A method for Proxy Call Session Control Function (P-CSCF) restoration in an IP Multimedia Subsystem (IMS) network, the method executed at one or more serving entities assigned for serving a user equipment (UE) in the IMS network and comprising:
receiving a register message originated from a UE via a P-CSCF entity, the register message initiating a registration procedure and comprising UE capability information indicating that the UE is enabled to receive a list with one or more further available P-CSCF entities and to re-register in the IMS network with one of them;
storing by the serving entity the received UE capability information; and
completing the registration procedure.

4. The method of claim 3, wherein the one or more serving entities receiving the register message include a Serving Call Session Control Function (S-CSCF) entity of the IMS network.

5. The method of claim 3, further comprising:
upon forwarding to the P-CSCF entity an invite message received by the one or more serving entities, detecting by at least one of the one or more serving entities unavailability of the P-CSCF entity to handle the invite message; and
sending from one of the at least one detecting serving entity towards an access network entity, via a Home Subscriber Server (HSS), a request to start P-CSCF restoration, wherein the request submitted to the access network entity includes the UE capability information.

6. The method of claim 5, wherein the one or more serving entities receiving the invite message include either a Serving Call Session Control Function (S-CSCF) entity, or an S-CSCF entity and an Application Server (AS) of the IMS network.

7. The method of claim 6, wherein the S-CSCF entity is the serving entity receiving and forwarding to the P-CSCF entity the invite message, detecting the unavailability of the P-CSCF entity, and sending the request to start P-CSCF restoration via the HSS.

8. The method of claim 6, wherein the S-CSCF entity and the AS are the one or more serving entities receiving the invite message, wherein the S-CSCF entity is the serving entity forwarding to the P-CSCF entity the invite message, wherein the S-CSCF entity and the AS are the serving entities detecting the unavailability of the P-CSCF entity, and wherein the AS is the serving entity sending the request to start P-CSCF restoration via the HSS.

9. The method of claim 3, wherein storing by the serving entity the received UE capability information includes one of either:
storing the received UE capability information in at least one of a Serving Call Session Control Function (S-CSCF) entity and an Application Server (AS) of the IMS network, or
submitting the received UE capability information from the receiver serving entity towards at least one of a Home Subscriber Server (HSS) and an Application Server (AS) for storing therein.

10. A method for Proxy Call Session Control Function (P-CSCF) restoration in an IP Multimedia Subsystem (IMS) network; the method executed at an access network entity through which a user equipment (UE) accesses the IMS network, and comprising:
receiving from an IMS network entity a request to start P-CSCF restoration, wherein the request includes UE capability information indicating that the UE is enabled to receive a list with one or more further available P-CSCF entities and to re-register in the IMS network with one of them;
obtaining from a gateway the list with one or more further available P-CSCF entities; and
sending to the UE a request intended to cause the UE to re-register in the IMS network, the request including the list with one or more further available P-CSCF entities.

11. The method of claim 10, wherein the access network entity is an entity in charge of mobility management.

12. The method of claim 11, wherein the access network entity is a mobility management entity (MME) and the gateway is at least one of a serving gateway (S-GW) and a packet data network gateway (P-GW).

13. The method of claim 11, wherein the access network entity is a serving GPRS support node (SGSN) and the gateway is a gateway GPRS support node (GGSN).

14. A user equipment (UE) enabled to communicate with an IP Multimedia Subsystem (IMS) network and comprising:
a transmitter adapted to send a register message to a Proxy Call Session Control Function (P-CSCF) entity of the IMS network, the register message initiating a registration procedure and comprising UE capability information indicating that the UE is enabled to receive a list with one or more further available P-CSCF entities and to re-register in the IMS network with one of them.

15. The UE of claim 14, further comprising:
a receiver adapted to receive from an access network entity a request intended to cause the UE to re-register in the IMS network, the request including a list with one or more further available P-CSCF entities; and
wherein the transmitter is further adapted to send a further register message to a further P-CSCF entity selected from the list with one or more further available P-CSCF entities.

16. A serving entity assigned for serving a user equipment (UE) in an IP Multimedia Subsystem (IMS) network and comprising:
a receiver adapted to receive a register message originated from a UE via a Proxy Call Session Control Function (P-CSCF) entity of the IMS network, the register message initiating a registration procedure and comprising UE capability information indicating that the UE is enabled to receive a list with one or more further available P-CSCF entities and to re-register in the IMS network with one of them; and
a processor adapted to trigger the received UE capability information being internally stored in a local memory or being submitted for storage, through a transmitter, towards a further serving entity, and also adapted to trigger completion of the registration procedure.

17. The serving entity of claim 16, further comprising a transmitter adapted to forward to the P-CSCF entity an invite message received by the serving entity, and wherein:
the processor is adapted to detect, upon forwarding to the P-CSCF entity the invite message, unavailability of the P-CSCF entity to handle the invite message; and
the transmitter is adapted to trigger the submission towards an access network entity, via at least one of a Home Subscriber Server (HSS) and a further serving entity, of a request to start P-CSCF restoration, wherein the request submitted to the access network entity includes the UE capability information.

18. The serving entity of claim 17, wherein the serving entity is a Serving Call Session Control Function (S-CSCF) entity and the further serving entity is an Application Server (AS) of the IMS network.

19. The serving entity of claim 18, wherein the transmitter of the S-CSCF entity is adapted to one of:
send the request to start P-CSCF restoration via the HSS; and
notify the AS of the unavailability of the P-CSCF entity to cause the AS to send the request to start P-CSCF restoration via the HSS.

20. The serving entity of claim 16, wherein the processor is adapted to store the received UE capability information in a local memory of the serving entity.

21. The serving entity of claim 16, wherein the transmitter is adapted to submit the received UE capability information towards at least one of a Home Subscriber Server (HSS) and an Application Server (AS) to be stored therein.

22. An access network entity for mobility management of a user equipment (UE) which accesses an IP Multimedia Subsystem (IMS) network, and comprising:
a receiver adapted to receive from an IMS network entity a request to start a Proxy Call Session Control Function, P-CSCF, restoration, wherein the request includes UE capability information indicating that the UE is enabled to receive a list with one or more further available P-CSCF entities and to re-register in the IMS network with one of them;
a processor adapted to obtain, from a gateway, the list with one or more further available P-CSCF entities; and
a transmitter adapted to send to the UE a request intended to cause the UE to re-register in the IMS network, the request including the list with one or more further available P-CSCF entities.

23. The access network entity of claim 22, wherein the access network entity is a mobility management entity (MME) and the gateway is at least one of a serving gateway (S-GW) and a packet data network gateway (P-GW).

24. The access network entity of claim 22, wherein the access network entity is a serving GPRS support node (SGSN) and the gateway is a gateway GPRS support node (GGSN).

25. A system for Proxy Call Session Control Function (P-CSCF) restoration in an IP Multimedia Subsystem (IMS) network, the system comprising:
a P-CSCF entity of the IMS network adapted to receive from a user equipment (UE) a register message with UE capability information indicating that the UE is enabled to receive a list with one or more further available P-CSCF entities and to re-register in the IMS network with one of them, and adapted to forward the register message with the UE capability information towards a Serving Call Session Control Function (S-CSCF) entity;
at least one of the S-CSCF entity, a Home Subscriber Server (HSS) and an Application Server (AS) of the IMS network adapted to receive and store the UE capability information;
wherein at least one of the S-CSCF entity and the AS is adapted to receive a terminating invite message, the S-CSCF entity is adapted to forward the terminating invite message towards the P-CSCF entity, and at least one of the S-CSCF entity and the AS is adapted to detect unavailability of the P-CSCF entity;
wherein at least one of the S-CSCF entity and the AS is adapted to send towards an access network entity, via the HSS, a request to start P-CSCF restoration, the request including the UE capability information; and
the access network entity adapted, based on the received UE capability information, to send to the UE a request intended to cause the UE to re-register in the IMS network, the request including a list with one or more further available P-CSCF entities.

26. A storage medium selected from an optical, magnetical, magneto-optical and semiconductor memory device, having stored therein computer program instructions which, when executed on at least one processor, cause the at least one processor to:
receive a register message, originated from a UE via a P-CSCF entity, the register message initiating a registration procedure and comprising UE capability information indicating that the UE is enabled to receive a list with one or more further available P-CSCF entities and to re-register in the IMS network with one of them;
store this UE capability information in at least one of a Serving Call Session Control Function (S-CSCF) entity, an Application Server (AS) and a Home Subscriber Server (HSS) of the IMS network;
provide the UE capability information via the HSS towards at least one of a mobility management entity (MME) and a serving GPRS support node (SGSN);
send, based on the received UE capability information, from the at least one of MME and SGSN to the UE, a list with one or more further available P-CSCF entities; and
receive from the UE a further register message at a further P-CSCF entity selected from the list with one or more further available P-CSCF entities.

27. A method for Proxy Call Session Control Function (P-CSCF) restoration in an IP Multimedia Subsystem (IMS) network, the method comprising:
a user equipment (UE) submitting to the IMS network, via a P-CSCF entity, a register message with UE capability information indicating that the UE is enabled to receive a list with one or more further available P-CSCF entities and to re-register in the IMS network with one of them;
storing this UE capability information in at least one of a Serving Call Session Control Function (S-CSCF) entity, an Application Server (AS) and a Home Subscriber Server (HSS)
of the IMS network;
upon detecting unavailability of the P-CSCF entity to handle a terminating request towards the UE, providing the UE capability information via the HSS towards at least one of a mobility management entity (MME) and a serving GPRS support node (SGSN);
based on the received UE capability information, the at least one of MME and SGSN sending to the UE a list with one or more further available P-CSCF entities; and
sending a further register message, from the UE to a further P-CSCF entity selected from the list with one or more further available P-CSCF entities.
